(19) United States
(12) Patent Application Publication
(10) Pub. No.: US 2007/0033283 A1
(43) Pub. Date: Feb. 8, 2007

(54) Method and system for managing electronic communication

(76) Inventor: Murray James Brown, Toronto (CA)

Correspondence Address: BENNETT JONES LLP, 3400 ONE FIRST CANADIAN PLACE, PO BOX 130, TORONTO, ON, M5X 1A4, CA

(21) Appl. No.: 11/340,665

(22) Filed: Jan. 27, 2006

Related U.S. Application Data
(60) Provisional application No. 60/705,185, filed on Aug. 4, 2005.

(51) Int. Cl. G06F 15/173

(52) U.S. Cl. 709/226

(57) ABSTRACT

The present invention provides a novel system and method for managing electronic communications. In one embodiment, a mail server is coupled to a client and a policy server. For an email outbound from the client, the email is first sent to the policy server which applies a policy against the email. If the email complies with the policy, the policy server generates a report which is attached to the email. The mail server is configured to refuse to send the outbound email without a report that indicates the email complies with the policy.

### PRIORITY CLAIM

The present application claims priority from U.S. Provisional Patent Application No. 60/705,185 filed Aug. 4, 2005, the contents of which are incorporated herein by reference.

### FIELD OF THE INVENTION

The present invention relates to electronic communications and more particularly relates to a method and system for management of electronic communications.

### BACKGROUND OF THE INVENTION

Threats to email and other electronic communications are not satisfactorily addressed in the prior art. Such threats include viruses, electronic eavesdropping, and spam (also known as unsolicited commercial email (“UCE”)).

Email antivirus protection solutions have evolved from desktop virus scanning products to include the scanning of messages inbound to and outbound from the workstation. Initially, security-conscious individuals installed and maintained their own anti-virus solutions by keeping their virus signature databases up-to-date. Their motivation was mainly for their own protection; outbound filtering was almost an afterthought.

As society evolved to expect enterprises not to propagate viruses, corporate-wide desktop solutions with outbound scanning became as important as inbound scanning. Yet, not all users maintained their systems with rigour and, as it became an administrative burden to manage the multitude of desktop systems, an alternative server-based solution was born: all email inbound and outbound from an enterprise was passed through a scanning filter that would identify virus-ridden messages and either quarantine or delete the message and (optionally) notify the originator. The efficacy of the scanner and the quality of the virus signature database can be managed centrally. Somewhat later, Internet Service Providers (“ISP”) also adopted this model; initially it was offered as a tiered value-added service but more recently it is becoming a core service feature. This same evolution of approaches has been seen in addressing the spam problem.

Concurrent with the foregoing evolution is a trend towards encrypting email from end-to-end, in order to reduce the likelihood of electronic eavesdropping. However, one problem with a centralized server-based virus scanner for end-to-end encrypted email is that it does not have access to the clear-text message content. Accordingly, virus signatures cannot be applied to encrypted content to determine whether a virus is contained within the message. With end-to-end encryption, only the intended recipients can decrypt and process a message so virus scanning can only occur prior to encryption at the origin, and subsequent to decryption at the destination.

One solution is to revert to the original model in which end-users maintain virus scanning software on their local client machines. However, this is unsatisfactory for the issues already discussed.

Another solution is to designate a server-based content scanner as a trusted agent that is allowed to decrypt enterprise email messages in order to perform virus scanning. However, this introduces another set of topology and logistic issues. In one model, the virus agent is deployed as a trusted intermediary which acts on behalf of the mail transport agent (“MTA”) (i.e., Simple Mail Transport Protocol (“SMTP”) mail server) to determine the disposition of an email. Such a determination can include whether to deliver the email to the intended recipients or discard or quarantine an infected message. The problem is that the virus scanner must either be an explicitly addressed recipient with its own public key and certificate (used by the originator to encrypt the shared secret message key included within the Secure Multipurpose Internet Message Extension (“S/MIME”) header) or the virus scanner must have access to one of the recipients' private keys. Clearly, multiple parties sharing a private key is a dubious security solution as it defeats the entire purpose of clearly identifying an originating machine. Although the former alternative has a more favourable security profile, it is deficient in terms of usability and efficacy—not every originator (especially external parties) of a secure message will necessarily always include the virus scanning agent in the list of addressees, nor will they likely be coached or coerced to do so, even over time.

### SUMMARY OF THE INVENTION

It is an object of the present invention to provide a novel method and system for managing electronic communications that obviates or mitigates at least one of the above-identified disadvantages of the prior art.

An aspect of the invention provides a system for managing electronic communication comprising at least one client connected to a network. Each client is operable to execute a user application for managing electronic communications carried over the network. Each client is also operable to execute a security module for intercepting the communications. The system also comprises a policy server connected via a link to each client. The policy server is operable to receive the electronic communications from the security module via the link. The policy server is operable to execute a policy manager configured for verifying that each of the communications comply with at least one policy and to generate an indicator representing whether each communication complies with the at least one policy. The policy manager is configured to return the indicator to the security module. The security module is configured to permit management of the communications at the client based on the indicator.

The link can be implemented as a secure communication link. The electronic communications can be text messages, emails or the like.

The system can also comprise a mail server between the network and the client. The mail server is operable to execute a mail transport agent. The mail transport agent is configured to permit or refuse delivery of outbound emails that are generated by the user application over the network based on the indicator respective to each of the outbound emails.

The at least one client in the system can further include a key store associated with the user application. The key store contains encryption keys for encrypting and decrypting the electronic communications.

The at least one policy in the system can be for verifying whether each of the outbound emails are encrypted and the indicator can represent whether each of the outbound email is encrypted.

The management of the electronic communication includes automatically encrypting each the outbound emails if the indicator reflects or represents that the outbound email is not encrypted. The automatic encryption can be performed at the client or at the mail server or at such other location as may be desired.

The policy server and the mail server can be operated by the same organization or different organizations. For example, the at least one client and the policy server can be operated by an enterprise while the mail server is operated by an Internet Service Provider.

The system can include a plurality of clients and at least one additional policy server connected to the mail server. Each of the policy servers can be connected to respective portions of the plurality of clients. Each of the policy servers can be configured to verify that each of the communications comply with at least one additional policy that is different from the at least one policy. Each of the policy servers can be operated by the same or different organizations.

The security module of the system can be configured to refuse to permit the user application to present an inbound electronic communication to a user at the client that is received at the client over the network if the indicator respective to the inbound electronic communication does not indicate compliance with the at least one policy. The security module can be configured to permit the user application to present an inbound electronic communication to a user at the client that is received at the client over the network if the indicator respective to the inbound electronic communication indicates compliance with the at least one policy.

The at least one policy scanner can include one or more of a virus scanner, a spam scanner and a recipient rule engine.

The at least one policy scanner can include a sensitivity scanner that scans for at least one of pre-defined character strings specified as regular expressions and heuristic or statistical method to identify potentially sensitive material.

The policy server can be operable to generate a hash of the electronic communication in addition to the indicator. The hash is associated with the indicator and is for verifying that the electronic communication is correctly associated with the indicator.

Another aspect of the invention provides a system for managing electronic communication over a network comprising at least one client. Each client is operable to execute a user application for creating and presenting electronic communications and a security module for intercepting the electronic communications as the communications are sent from the user application or prior to reception by the user application. The system also comprises a policy server connected via a link to each client and is operable to receive the electronic communications from the security module. The policy server is operable to execute a policy manager for verifying that the communications comply with the at least one policy and to generate an indicator representing whether the communications comply with the at least one policy. The policy manager is further operable to return the indicator to the security module. The security module is further operable to permit further handling of the communications if the indicator represents that the communications comply with the policy.

Another aspect of the invention provides a system for managing electronic communication over a network comprising at least one client. Each client is operable to execute a user application for creating outbound electronic communications for delivery over the network and for presenting inbound electronic communications received over the network. Each client is further operable to execute a module for intercepting the outbound electronic communications as the communications are sent from the user application and for intercepting the inbound electronic communications prior to reception by the user application. The system further comprises a policy server connected via a link to each client. The policy server is operable to receive the electronic communications from the security module. The policy server is operable to execute a policy manager for verifying that the communications comply with at least one policy and to generate an indicator representing whether the communications comply with the at least one policy. The policy manager is further operable to return the indicator to the security module. The security module is further operable to permit further handling of the communications based on the indicator.

Another aspect of the invention provides a system for managing electronic communication over a network comprising at least one client. Each client is operable to execute a user application for creating outbound electronic communications for delivery over the network. Each client is further operable to execute a module for intercepting the outbound electronic communications as the communications are sent from the user application. The system also includes a policy server connected via a link to each client. The policy server is operable to receive the electronic communications from the security module. The policy server is operable to execute a policy manager for verifying that the communications comply with at least one policy and to generate an indicator representing whether the communications comply with the at least one policy. The policy manager is further operable to return the indicator to the security module. The security module is further operable to permit further handling of the communications based on the indicator.

Another aspect of the invention provides a system for managing electronic communication comprising at least one client connected to a network. Each client is operable to execute a user application for managing electronic communications carried over the network. The client is further operable to execute a security module for intercepting the communications. The system also includes a policy server connected via a link to each client. The policy server is operable to receive the electronic communications from the security module. The policy server is operable to execute a policy manager configured for verifying that each of the communications comply with at least one policy and to generate an indicator representing whether the communication complies with the at least one policy. The policy manager is configured to return the indicator to the security module. The security module is configured to permit further handling of the communications by the user application based on the indicator.

Another aspect of the invention provides a method for managing an outbound electronic communication from a client comprising the steps of:
generating an outbound email;
forwarding the email to a policy server for determining whether the email complies with at least one policy;
receiving a policy compliance report from the policy server; and,
forwarding the email and the policy compliance report to a mail server if the policy compliance report indicates the email complies with the at least one policy.

If the policy compliance report indicates the email conditionally complies with the at least one policy then the method can further comprise the step of, after the receiving step, automatically performing an operation that brings the outbound email into compliance with the at least one policy. The operation can comprise encrypting the email and/or digitally signing the email.

Another aspect of the invention provides a method for managing an electronic communication at a client comprising the steps of:
intercepting an email at the client;
forwarding the email to a policy server for determining whether the email complies with at least one policy;
receiving a policy compliance report from the policy server; and,
managing the email in accordance with the policy compliance report.

Another aspect of the invention provides a method of managing an electronic communication at a policy server comprising the steps of:
receiving an email from a client;
applying at least one policy to the email;
generating a policy compliance report based on results of the applying step;
the report including-an indicator whether the email is in compliance with the policy, and,
returning the compliance report to the client.

The at least one policy can include one or more of a virus scanner, a spam scanner and a recipient rule engine. The at least one policy scanner can include a sensitivity scanner that scans for at least one of pre-defined character strings, social security numbers, account numbers, customer names, and dates of birth.

The policy server can further generate a hash of the electronic communication. The hash is incorporated into the policy compliance report and is for verifying that the electronic communication is correctly associated with the indicator.

Another aspect of the invention provides a method of managing an electronic communication at a mail server comprising:
receiving an email generated by a client for delivery over a network;
receiving a policy compliance report associated with the email;
forwarding the email for delivery over the network if the policy compliance report indicates the email complies with the at least one policy.

If the policy compliance report indicates the email conditionally complies with the at least one policy then the method can further comprise the step of, after the receiving step, automatically performing an operation that brings the outbound email into compliance with the at least one policy. The operation can comprise encrypting and/or digitally signing the email.

### BRIEF DESCRIPTION OF THE DRAWINGS

The invention will now be described by way of example only, and with reference to the accompanying drawings, in which:

FIG. 1 is a schematic representation of a system for managing electronic communications in accordance with an embodiment of the invention;

FIG. 2 shows the system of FIG. 1 in greater detail;

FIG. 3 shows a flow-chart depicting a method for managing electronic communications from a client in accordance with another embodiment of the invention;

FIG. 4 shows a flow-chart depicting a method for managing electronic communications at a policy server in accordance with another embodiment of the invention;

FIG. 5 shows a flow-chart depicting a method for managing electronic communications from a mail server in accordance with another embodiment of the invention;

FIG. 6 shows a screen-shot of an exemplary email that is managed using various embodiments described herein;

FIG. 7 shows the system of FIG. 2 during the performance of the certain steps in the methods in FIGS. 3 and 4;

FIG. 8 shows the system of FIG. 2 during the performance of the certain steps in the methods in FIGS. 3 and 4;

FIG. 9 shows the system of FIG. 2 during the performance of the certain steps in the methods in FIGS. 3 and 5;

FIG. 10 shows a flow-chart depicting a method for performing one of the steps in method 300 or method 500 and in accordance with another embodiment of the invention;

FIG. 11 shows a flow-chart depicting a method for managing electronic communications to a client in accordance with another embodiment of the invention;

FIG. 12 shows a flow-chart depicting a method for managing electronic communications at a policy server in accordance with another embodiment of the invention;

FIG. 13 shows the system of FIG. 2 during the performance of the certain steps in the methods in FIGS. 11 and 12;

FIG. 14 shows the system of FIG. 2 during the performance of the certain steps in the methods in FIGS. 11 and 12;

FIG. 15 shows the system of FIG. 2 during the performance of the certain steps in the methods in FIGS. 11 and 12;

FIG. 16 is a schematic representation of a system for managing electronic communications in accordance with another embodiment of the invention; and

FIG. 17 is a schematic representation of a system for managing electronic communications in accordance with another embodiment of the invention.

### DETAILED DESCRIPTION OF THE INVENTION

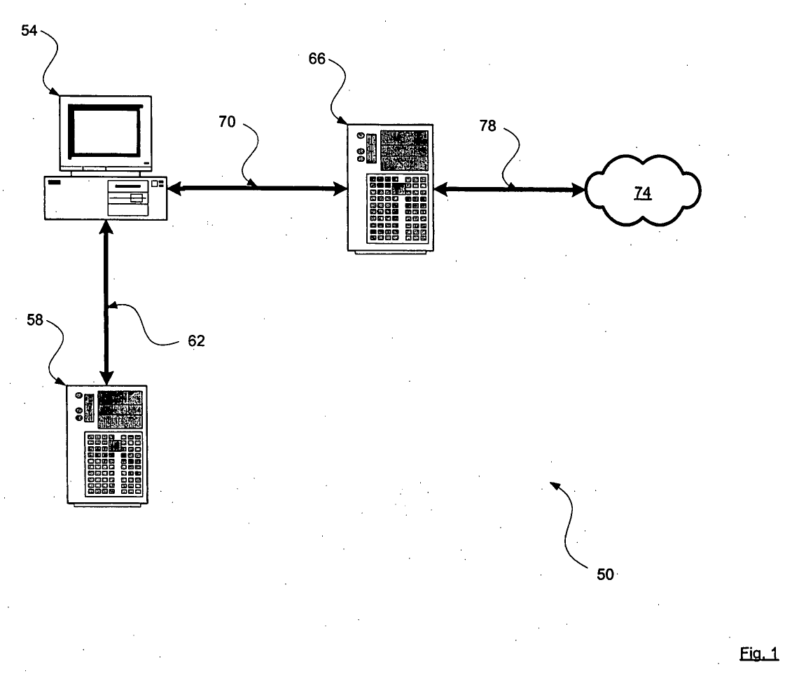

Referring now to FIG. 1, a system for managing electronic communications is indicated generally at 50. System 50 comprises a plurality of clients 54 intermediately connected to a policy server 58 via a first link 62 and a mail server 66 via a second link 70. In turn, mail server 66 is connected to a network 74 via a third link 78.

While a plurality of clients 54 are contemplated in a typical implementation (but-are not required), only one client 54 is shown in FIG. 1 to simplify explanation of the embodiment. Each client 54 is typically a computing device such as a personal computer having a keyboard and mouse (or other input devices), a monitor (or other output device) and a desktop-module connecting the keyboard, mouse and monitor. The desktop-module houses one or more central processing units, volatile memory (for example; random access memory), persistent memory (for example, hard disk devices) and network interfaces to allow the client 54 to connect to policy server 58 (through link 62) and network 74 via mail server 66 (through link 70 and 78). However, it is to be understood that in other embodiments client 54 can be any type of computing device, such as a personal digital assistant, cell phone, laptop computer, email paging device etc.

In a present embodiment, the electronic communications managed by system 50 are emails. In other embodiments other types of electronic communications can be managed. As used herein, the term “email” also implicitly includes any attachments to that email, regardless of the form of attachment, be they applications, graphics files, text files, audio files, video files, and/or other emails which in themselves may or may not include further attachments. Thus, each client 54 is operated by a user wishing to send and receive emails, and, as will be explained further below, client 54 is generally operable to execute at least an email user application or Mail User Agent (“MUA”), such as Microsoft Outlook, Eudora, Lotus Notes or the like, in order to enable the user to send and receive emails over network 74.

Policy server 58 and mail server 66 can be based on any type of computing environment suitable for performing server-type functions, such functions being more particularly described below, according to the scale and/or speed that is desired and/or number of clients, (such as client 54), that are to be served by each. For example, servers 58 and 66 can be a Sun 480R server from Sun Microsystems, Inc. of Palo Alto, Calif., which has four central processing units (“CPUs”) and, because speed can be desired, such a server can be configured with about two to about five gigabytes (or more) of random access memory (“RAM”). However, it is to be emphasized that this particular model server is merely exemplary, a vast array of other types of computing environments, (either presently known or as yet unconceived) are within the scope of the invention.

Whichever computing environment is chosen, policy server 58 is generally operable to process inbound and outbound emails for client 54 according to a predetermined policy,.and mail server 66 is generally operable to verify that policy server 58 has applied the policy against emails, as part of performing its function as a gateway for emails between network 74 and client 54. Those of skill in the art will now recognize that mail server 66 includes substantially the same functionality as any traditional, well-known, off-the-shelf mail server that is currently known or as yet unconceived. However, as will be explained further below, mail server 66 is modified to allow it to perform the above-mentioned verification.

Network 74 can be wired or wireless, or based on combinations thereof, and based on any type of known network architecture or platform or combinations thereof. Network 74 is typically the Internet, but it can be any other type of medium through which client 54 can send and receive emails. For example, network 74 can be an intranet, a wide area network, a local area network or the like. Network 74 can be wired or wireless, or based on combinations thereof. Network 74 is thus operable to forward emails originating from client 54 to destinations within network 74 via mail server 66, and to forward emails originating from destinations within network 74 to client 54 via mail server 66.

Likewise, the structure and implementation of links 62, 70 and 78 are not particularly limited. Links 62 and 70 can be implemented as separate physical links, or can be merged into one physical link and implemented as two virtual links. For example, where client 54, server 58 and server 66 are housed or operated within a single enterprise, then links 62 and 70 can be implemented as a portion of a single intranet or local area network within the enterprise. Continuing with the example of client 54, server 58 and server 66 being housed or operated within a single enterprise, then link 78 can be a backhaul such as a T1, T3 or other link that connects the enterprise to network 74, which in this example is the Internet. Other structural implementations for links 62, 70 and 78, be they wired, wireless, or based on a variety of different protocols that will now occur to those of skill in the art.

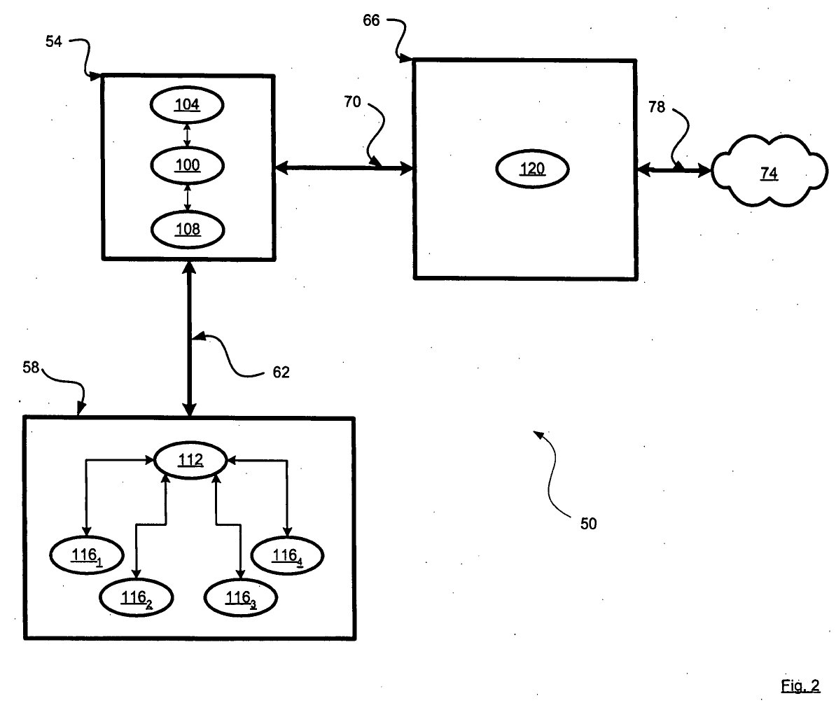

Referring now to FIG. 2, system 50 is redrawn to show representations of different software processes and data files local to client 54 and servers 58 and 66, which are represented as ovals. Any suitable programming language can be used to implement such processes and data files. For convenience, processes and data files and the like will be collectively referred to as software objects, though the use of the term ‘object’ should not be construed in a limiting sense, such as being strictly limited to “software objects” referred to in object oriented programming languages. Further, while software objects are used in the present embodiment, at least some or all of software objects can be hard-coded into central processing units and/or read only memories in client 54, server 68 and server 66.

In FIG. 2, client 54 is shown executing an email user application 100, which in a present embodiment is based on Microsoft Outlook. (In other embodiments the email user application can be based on Eudora, Lotus Notes or any other known or as yet unconceived application of the like).

Client 54 also maintains a key store 104. Key store 104 stores a digital certificate (not shown) that itself stores a public key (not shown) associated with the user at client 54, and a private key (not shown) complementary to the public key stored inside the digital certificate. Email user application 100 is operable, in the usual manner, to access key store 104 to perform digital signature and encryption/decryption functions associated with emails that are being handled by email user application 100.

Client 54 also executes a security module 108 that is a “plug-in” to email user application 100. As used herein, the term “plug-in” is intended to denote that security module 108 becomes an application that is, in a functional sense, seamlessly available to a user of email user application 100. Thus, in the present embodiment, Microsoft Outlook operates in substantially all the usual ways, except that the user of email user application 100 can access the features of security module 108 directly from menus and/or dialogue boxes from within email user application 100. Features of security module 108 can include seamless, user-friendly access to key store 104 via email user application 100. In any event, security module 108 is generally operable to intercept emails associated with email user application 100 and cause those emails to be processed by policy engine 58. Security module 108 can be based on (with appropriate modifications) the functionality of Echoworx Secure Email™, available from Echoworx Corporation, 4101 Yonge Street, Suite 708, Toronto, Ontario, Canada M2P 1N6, and/or the teachings in U.S. Pat. No. 6,678,821, “Method and System For Restricting Access to the Private Key of a User in a Public Key Infrastructure”; and/or the teachings in Patent Application PCT/CA03/01102, “System, Method and Computer Product for Delivery and Receipt of S/MIME Encrypted Data”.

In FIG. 2, policy server 58 is shown executing a policy manager 112 which in turn is able to access a plurality of policy components 116₁, 116₂, 116₃, 116₄. (Collectively referred to as policy components 116, and generically, policy component 116). Policy components 116 also execute on server 58, and are centrally accessible via policy manager 112. Policy manager 112 is operable to communicate with email user application 100 via security module 108. Policy manager 112 is also operable to verify that emails associated with email user application 100 comply with pre-defined criteria. If emails associated with user application 100 comply with those criteria, then an appropriate indication is returned to email user application 100.

Policy components 116 provide the pre-defined rules, definitions and any other criteria used by policy manager 112 and by which emails associated with email user application 100 need to comply. Thus, the functionality of policy components 116 is not particularly limited and can include any type of criteria upon which an operation is performed on such emails. In a present, exemplary embodiment, policy component 116₁, is a sensitivity scanner; policy component 116₂ is a virus scanner; policy component 116₃ is a spam scanner; and policy component 116₄ is a recipient rule engine.

Sensitivity scanner policy component 116₁, thus includes software that enables the scanning of the contents of an email for any sensitive information. Sensitive information can include, for example, a particular text string that identifies that the contents of the email include information which is confidential and should be maintained as confidential. Continuing with this example, assume that client 54 belongs to a particular enterprise that is engaged in a project called “Project X”. Assume also that the user at client 54 sends and receives emails that refer to “Project X”. The string “Project X” can then be programmed into sensitivity scanner policy component 116₁, to identify whether the email is of a confidential nature. Other types of sensitive information can include Social Security Numbers, Account numbers, customer names, dates of birth, etc. If sensitive information is found, then a rule can be associated with that information requiring encryption of the email, or transmission of the email can be blocked entirely and/or quarantined and/or a notice of suspicion can be logged or sent to an administrator for investigation.

Virus scanner policy component 116₂ thus includes software that enables the scanning of the contents of an email for viruses, trojan horses-or other malicious code. Virus scanner policy component 116₂ can thus be based on the core functionality of any well-known virus scanning software packages such as Managed VirusScan® from McAfee, Inc. of Santa Clara, Calif.

Likewise, spam scanner policy component 116₃ thus includes software that enables the scanning of the contents of an email for spam email. Spam scanner policy component 116₃ can thus be based on the core functionality of any well-known spam scanning software package such as McAfee®D SpamKiller™ from McAfee, Inc. of Santa Clara, Calif.

Likewise, recipient rule engine policy component 116₃ thus includes software that enables the scanning of the contents of the addressees of an email. Such a scan can then be compared against a known list of addressees, and where a particular addressee is found, a rule associated with that addressee can be enforced. For example, a rule can require that emails destined for that addressee be digitally signed and/or encrypted. Alternatively, emails destined for that addressee may be blocked.

It should now be apparent that other types of policy components can be included. Further, it should now also be apparent that the functionalities of each policy component 116 can have criteria that are independent of and/or interrelate with and/or depend on each other. For example, sensitivity scanner policy component 116₁ may cooperate with recipient rule engine policy component 116₃ to ensure that emails with certain sensitive contents are only sent to certain addressees.

In FIG. 2, mail server 66 is shown executing a mail transport agent 120. Mail transport agent 120 is generally operable, in the usual manner, to direct emails that are outbound from client 54 to network 74 for delivery to the appropriate recipient; and to direct emails that are inbound from network 74 to client 54. Mail transport agent 120 can thus be based on, for example, Microsoft Exchange from Microsoft Corporation, Redmond, Wash., or on any other known (or as yet unconceived) mail server application, whether based on the Post Office Protocol (“POP”), Internet Message Access Protocol (“IMAP”), Simple Mail Transport Protocol (“SMTP”) or other such protocol. Of note, however, mail transport agent 120 and email user application 100 are chosen or configured so that they can cooperate with each other in the delivery and receipt of email between client 54 and network 74. Mail transport agent 120 is also operable to verify that emails outbound from email user application 100 have been processed by policy manager 112 prior to forwarding those emails to network 74.

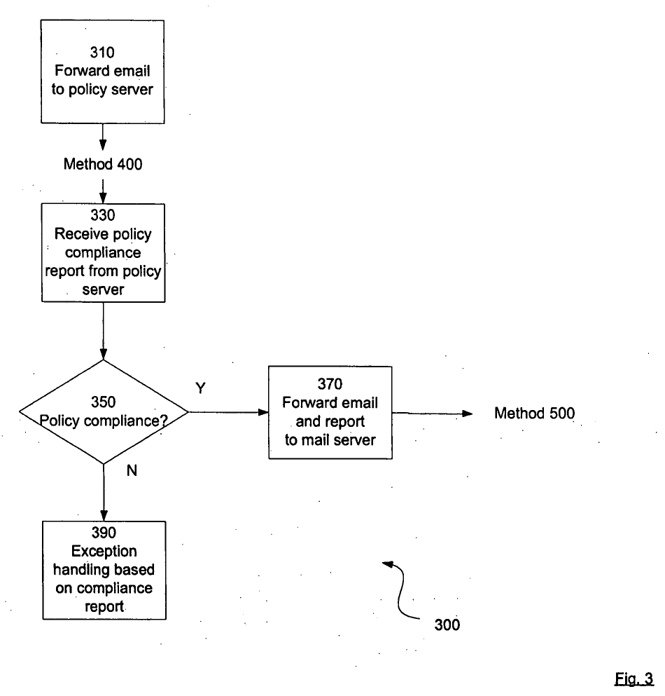

Referring now to FIGS. 3, 4 and 5, various methods for managing electronic communications in accordance with other embodiments of the invention are provided. In order to assist in the explanation of these methods, it will be assumed that they are performed using system 50. Furthermore, the following discussion of these methods will lead to further understanding of system 50 and its various components. However, it is to be understood that system 50 and/or the methods can be varied, and need not work together exactly as discussed herein, and that such variations are within the scope of the present invention. For example, the order of performance of various steps can be varied, and certain steps can be omitted and/or additional steps added: as desired.

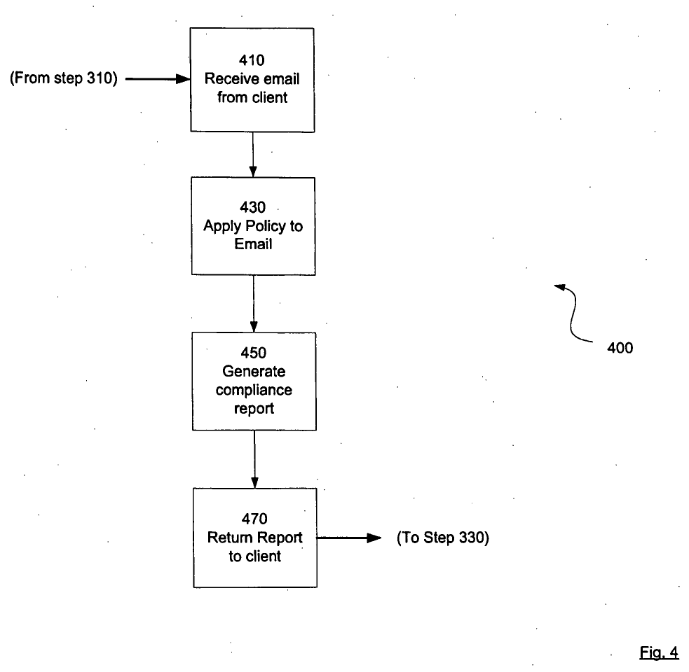

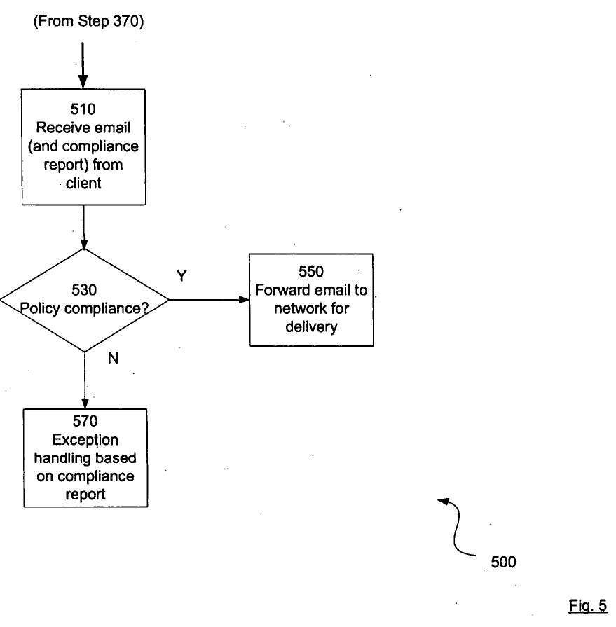

With this in mind, methods 300, 400 and 500 are generally directed to management of an email that is outbound from client 54 and destined to a recipient in network 74. Method 300 in FIG. 3 is a method for managing outbound emails at a client such as client 54. Method 400 in FIG. 4 is a method for managing outbound emails at a policy server such as policy server 58, while method 500 in FIG. 5 is a method for managing outbound emails at a mail server-such as mail server 66. For convenience, these methods will be explained in conjunction with each other.

Before explaining methods 300, 400 and 500, certain assumptions will be made. First, it is assumed that email user application 10 has been invoked and used to compose an email with the attributes as shown in Table I.

TABLE I
Attributes of Email 124

| Attribute Number | Name | Contents |
|---|---|---|
| Attribute 1) | Recipient | John.smith@recipientdomain.com |
| Attribute 2) | Sender | fred.jones@senderdomain.com |
| Attribute 3) | Subject | Project X |
| Attribute 4) | Body | John, can we meet next |
| | | Friday to discuss Project X? |
| Attribute 5) | Attachment | fredjones.vcf |

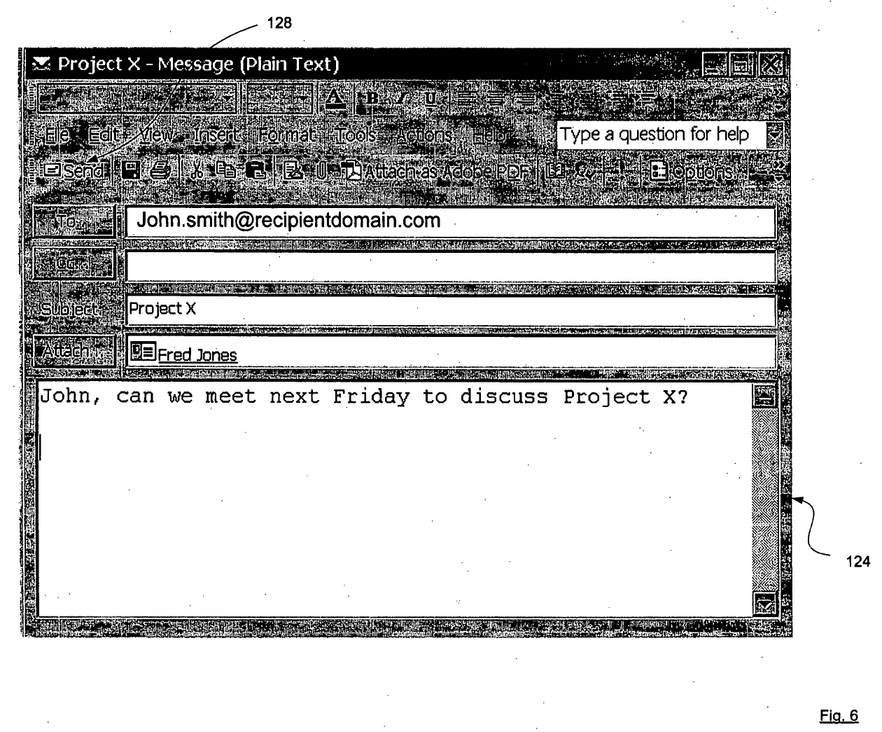

A graphical representation of this email is also indicated generally at 124 in FIG. 6. It is thus assumed that the sender of this email, Fred Jones, is the user at client 54 executing email user application 100. Upon composition of email 124, it is then assumed that the user issues a “send” command, such as by “pointing and clicking” on the “send” button, indicated at 128 in FIG. 6. At this point, and in a present embodiment, method 300 commences without further involvement from the user.

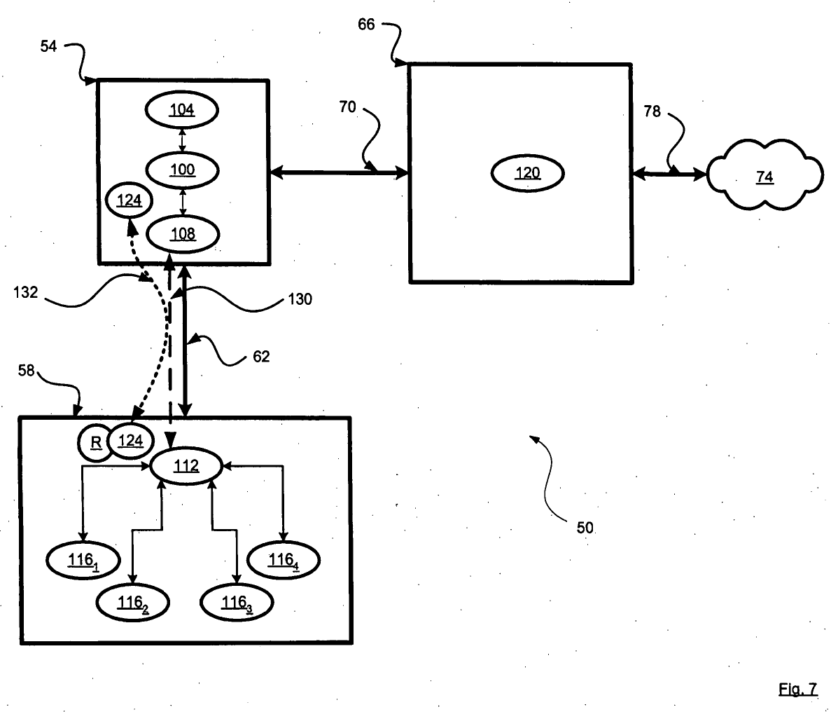

Referring now to FIG. 3, and beginning first at step 310, an outbound email is forwarded to a policy manager. Performance of this step, when implemented on system 50 on email 124, is represented in FIG. 7, and involves a number of sub-steps. First, security module 108 sets up a secure communication layer 130 with policy manager 112 over link 62.

Secure communication layer 130 can be implemented in any desired manner, and a presently preferred manner is to utilize the Secure Sockets Layer (“SSL”) protocol (or a variant thereof such as SSLv3) or the Transport Layer Security (“TLS”) protocol, which provides a high degree of confidentiality, integrity and authenticity of messages exchanged between the client MUA and the policy server 58. Next, security module 108 sends email 124 over layer 130 to policy manager 112 along the path indicated at 132 so that a copy of email 124 is locally resident on policy server 58.

At this point, method 300 pauses for the performance of method 400. Before completing the description of method 300, reference will now turn to method 400 on FIG. 4. Beginning first at step 410, the email 124 is received from client 54, as forwarded at step 310, and a copy of which is now locally resident on policy server 58 as shown in FIG. 7.

Next, at step 430, the policy is applied to the email. As previously discussed, any one or more of policy components 116 can now be applied against email 124 to verify whether it is in compliance with a pre-defined policy associated with outbound emails for client 54. To present a simplified example, it will be assumed that only sensitivity scanner policy component 116₁ and recipient rule engine policy component 116₄ are active and part of the pre-defined policy. It will also be assumed that sensitivity scanner policy component 116₁ includes the string “Project X”, which instructs policy manager 112 to examine recipient rule engine policy component 116₄ to verify that the recipient of email 124 is approved to receive emails that contain the string “Project X”. For this example, it will be assumed that recipient rule engine policy component 116₄ includes

“John.smith@recipientdomain.com” as being approved to receive emails that contain the string “Project X”.

Accordingly, on the performance of step 430, a report can be generated at step 450 indicating whether or not email 124 is in compliance with the pre-defined policy. In the example above:
(a) email 124 contains the sensitive string “Project X” and accordingly email 124 causes policy manager 112 to invoke the examination of recipient rule engine policy component 116₄; and
(b) upon such invocation, policy manager 112 utilizes recipient rule engine policy component 116₄ to determine that the recipient “John.smith@recipientdomain.com” is an approved recipient. Accordingly, the report generated at step 450 will indicate that email 124 complies with the pre-defined policy.

The performance step 450, according to this example, is represented in FIG. 7, as a Report R is shown attached to email 124. The contents of Report R, according to this example, is indicated in Table II.

TABLE II
Report R

| Field | | |
|---|---|---|
| Number | Field Name | Contents |
| 1 | Message complies with policy? | Yes |
| 2 | Message digest | Hash value of email message |

Report R in Table II thus includes two fields, one entitled “Message Complies with Policy?” and the contents of that field is simply a flag that indicates “Yes”; another field, entitled “Message digest”, contains the hash value of the message.

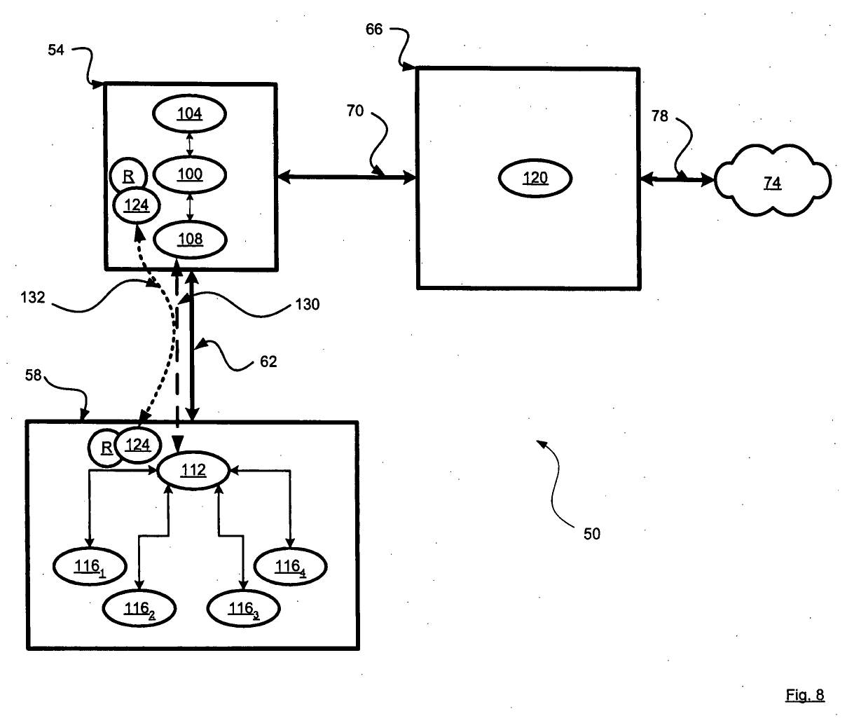

Referring again to FIG. 4, method 400 now advances to step 470, at which point Report R is returned to client 54. In a present embodiment Report R is sent back to security module 108 via path 132, as represented in FIG. 8. (Report R is typically, though not necessarily, digitally signed by policy server 58, using an encryption key that is private to engine policy server 58, such that the digital signature attached to Report R can allow the authenticity of Report R to be verified by other computing devices, such as client 54 and mail server 66, which may receive Report R.) At this point, path 132 closes, and the copy of email 124 and Report R can be (though need not be) deleted from policy server 58. Policy server 58, at this point, may also maintain a transaction record of the fact that method 400 had been performed on email 124 for archival purposes. Indeed, the email itself may be archived for business continuity, regulatory compliance or other purposes. Such regulatory compliance is becoming increasingly important with Sarbanes Oxley and other related initiatives.

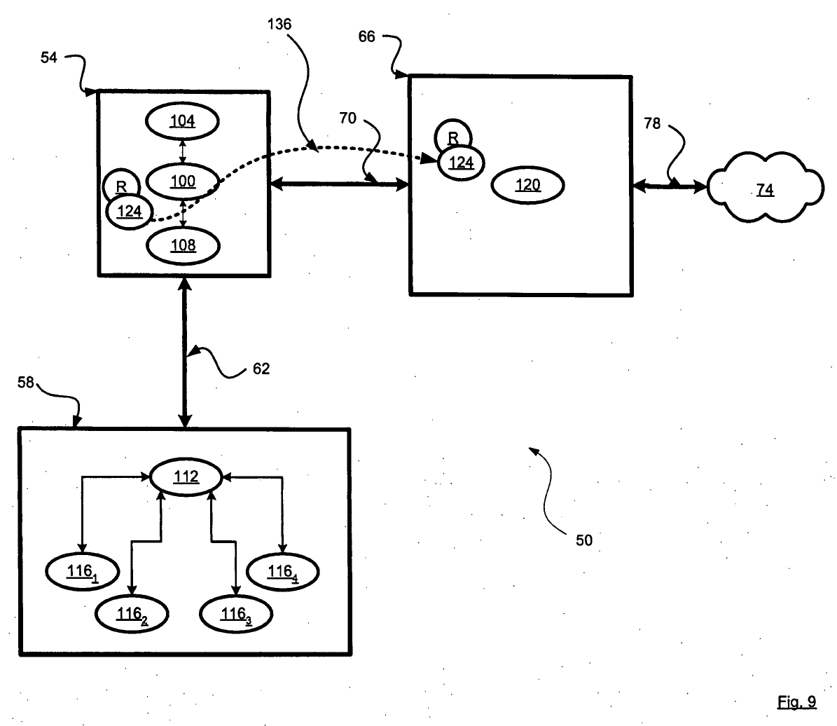

Referring again to FIG. 3, now that method 400 has been performed, method 300 now resumes at step 330 with the client receiving the policy compliance report generated by the policy server. In the present example, security module 108 will receive Report R and attach it to the local copy of email 124. Next, at step 350, a determination whether the email complied with the policy applied by the policy server is made. In order to perform this step, security module 108 can examine the contents of Report R and determine from Field 1 that “Yes”, policy server 58 determined that email 124 was in compliance with the prescribed policy. At that point method 300 advances to step 370 where the email and the compliance report are forwarded to the mail server for further handling. This step is represented in FIG. 9, as email 124 and Report R are forwarded to mail server 66 (in substantially the same manner as already performed between a client and a mail server) along a path 136 opened along link 70.

(If, however, at step 350 it was determined that “No”, email 124 was NOT in compliance with the prescribed policy, then method 300 would advance from step 350 to step 390, at which point an exception handling could be effected. Further discussion about various possible exception handling techniques is provided below.)

Having performed step 370, method 300 terminates and method 500 on FIG. 5 commences. Beginning first at step 510, the email and (assuming a compliance report is available) the compliance report are received from the client 54. This step was previously represented in FIG. 9, as email 124 and Report R were sent to mail server 66 via path 136. In a present embodiment, email 124 and Report R are received by mail transport agent 120 executing on server 66. Next, at step 530, a determination whether the email received at step 510 complies with the policy associated therewith is made. In the present example, mail transport agent 120 will perform this step by examining the contents of Report R (previously shown in Table I), and determine from Field 1 that “Yes” the email does comply with the policy. At this point, method 500 will advance to step 550, and email 124 will be sent to its destination by forwarding email 124 to network 74 in the usual manner.

(If, however, at step 530 Report R contained “No” in Field 1, and the email received at step 510 was NOT in compliance with the policy associated therewith, then method 500 would advance to step 570 for exception handling. Non-compliance at step 530 (leading to step 570) could occur for a variety of reasons. For example, an examination of the contents of report R could reveal that Field 1 of Table I indicated that “No”, the email did not comply with the policy. By the same token, where no report was ever attached to the email (i.e. only an email was received at step 510, and no compliance report was attached therewith), then the determination would be made that the email did not comply with the policy and the method 500 would advance from step 530 to step 570. Further discussion about various possible exception handling techniques is provided below.)

This completes a description of the performance of methods 300, 400 and 500, including an example of an email that complied with a specific policy. This description was simplified to facilitate explanation of certain embodiments. It should be understood, however, that a number of variations and modifications can be effected to system 50, method 300, method 400 and/or method 500 which are within the scope of the invention.

For example, the types of policies that are applied at step 430 are virtually limitless. Several illustrative examples can be offered, which may be applied alone or in combination with each other or earlier examples of policies. As one example of a policy that can be applied at step 430, assume that a virus scanner policy component 116₂ is run against the contents of email 124 or the like by policy manager 112. Virus scanner policy component 116₂ can perform a virus scan against email 124, and take various steps according to the results of that scan. If no virus is found then Field 1 of Report R in Table II can be populated with a “Yes”. If a virus is found, then Field 1 of Report R in Table II can be populated with a “No”, thereby leading to a “No” determination at step 350, or step 530 if the email were to actually reach mail server 66. Alternatively, if a virus is found, and virus scanner policy component 116₂ successfully quarantines (and/or deletes) the virus from email 124, then Field 1 of Report R in Table II can be populated with a “Yes” at step 450, and, optionally, additional fields can be added to Report R outlining the results of the virus scan. In this latter example, the quarantined version of email 124 would be returned from policy server 58 to mail client 54 and the original copy of email 124 would be deleted by mail client 54 and replaced with the quarantined version.

As another example of a policy that can be applied at step 430, assume that spam scanner policy component 116₃ is run against the contents of email 124 or the like by policy manager 112. Spam scanner policy component 116₃ can perform a spam scan against email 124, and take various steps according to the results of that scan. If email 124 is found to contain no spam, then Field 1 of Report R in Table II can be populated with a “Yes”. If spam is found, then Field 1 of Report R in Table H can be populated with a “No”, thereby leading to a “No” determination at step 350, or step 530 if the email were to actually reach mail server 66.

As another example of a policy that can be applied at step 430, assume that sensitivity scanner policy component 116, requires encryption of emails that contain certain contents, and/or recipient scanner policy component 116₄ requires encryption of emails that are addressed to certain recipients. In this situation, Field 1 of Report R can be populated with a flag indicating “Conditional” acceptance, and additional fields can be added to specify that the condition requires that the email be encrypted. The contents of Report R, now denoted as R₁, according to this example, are indicated in Table III.

TABLE III
Report R₁

| Field | | |
|---|---|---|
| Number | Field Name | Contents |
| 1 | Message complies with policy? | Conditional |
| 2 | Condition | Email must be encrypted |
| 3 | Message digest | Hash value of email message |

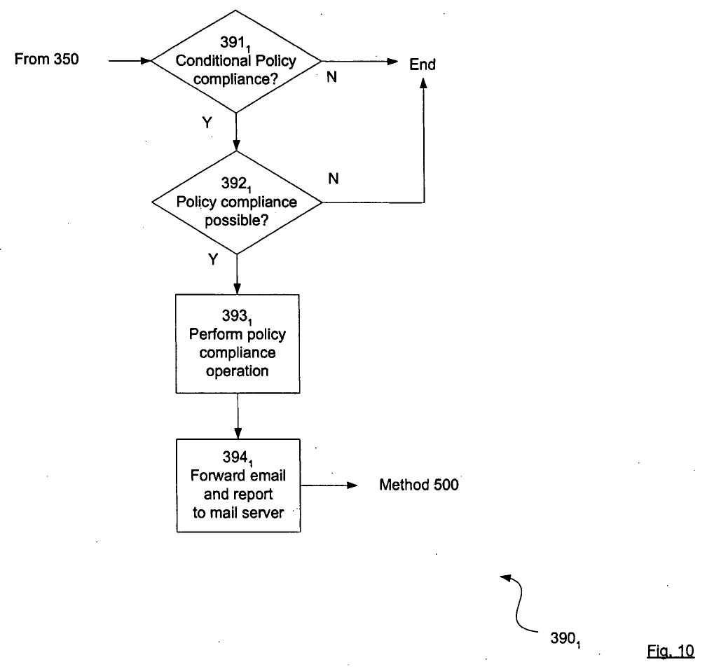

When step 430 is performed as described in the previous paragraph, to generate Report R₁, then it will be apparent that when step 350 is performed, a determination will be made that “No”, there is no policy compliance and method 300 will advance from step 350 to step 390 for exception handling. FIG. 10 shows a flowchart depicting a method 390₁, which is an example of one way that step 390 can be performed in client 54 (e.g. by security module 108) in order to handle an email having a report in the format of Report R₁ attached thereto.

Explaining method 390₁ in greater detail, at step 391₁ a determination is made as to whether there is even conditional policy compliance. For example, if Field 1 of Report R₁ contained “No”, then a determination would be made at step 391₁ that “No”, there is no conditional policy compliance and the method would end, with the option of an error message being presented to the user at client 54 explaining why the sending of the email failed. However, since Field 1 of Report R₁ contains “Conditional”, then a determination is made at step 391₁ that “Yes”, there is conditional policy compliance and method 390₁ advances to step 392₁. At step 392₁ a determination is made as to whether policy compliance is even possible. For example, since Field 2 of Report R₂ contains “Email must be encrypted”, then a determination would be made at step 392₁ as to whether it is even possible to encrypt the email. Assuming that, for example, key store 104 contains no encryption keys whatsoever, then it would be determined at step 392₁ that “No”, policy compliance is not even possible and the method would end, with the option of an error message being presented to the user at client 54 that communicates a message such as “Send command failed. Email must be encrypted. Encryption keys required.”

However, assume that, at step 392₁ a determination that policy compliance is possible—perhaps because an examination of key store 104 showed that key store 104 contained the requisite encryption keys needed to encrypt to the recipients of the email associated with Report R₁. In this case, method 390₁ would advance from step 392₁ to step 393₁ and, a policy compliance operation would be performed in order to bring the email in compliance with the policy. In this example, step 393₁ would be performed by security module 108, which would invoke the email encryption facilities inherent in email user application 100, in conjunction with key store 104, to apply the appropriate encryption to the email in the usual manner, thereby bringing the email into compliance with the policy. At the same time, Field 1 of Report R₁ can be updated to indicate “Yes”, reflecting that the email is now in compliance with the policy. At this point, method 390₁ would advance from step 393₁ to step 394₁ forwarding the email and the compliance report to the mail server. Step 394₁ would be performed in substantially the same manner as step 370 earlier described.

Returning to the example whereby step 450 of method 400 generates a report in the format of Report R₁, as another variation assume that step 350 of method 300 is configured such that a conditional policy compliance within Report R₁ is sufficient for a determination at step 350 that “Yes” there is policy compliance. This causes, at step 370, the unencrypted email and Report R₁ to be forwarded to the mail server, but Report R₁ still indicates that the email must be encrypted prior to forwarding the email to network 74. In this situation, a version of method 390₁ could-be performed by mail server 66, in place of step 570. Thus, mail server 66 would include an encryption module that permits encryption of the email on behalf of the enterprise that operates client 54 and/or mail server 66, obviating the need for client 54 to encrypt the email.

It should now be apparent that method 390₁ can be used for other exception handling situations, at either client 54 or mail server 66, involving conditional compliance being attached to specific emails, such that method 390₁ will automatically bring the email into compliance with the relevant policy.

This completes a description of certain examples of the types of policies that can be applied at step 430, such examples being illustrative and not exhaustive.

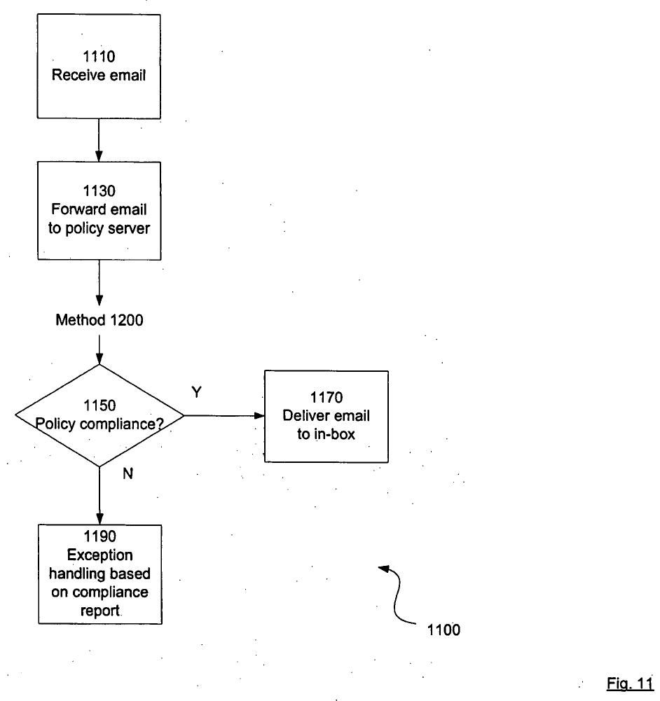

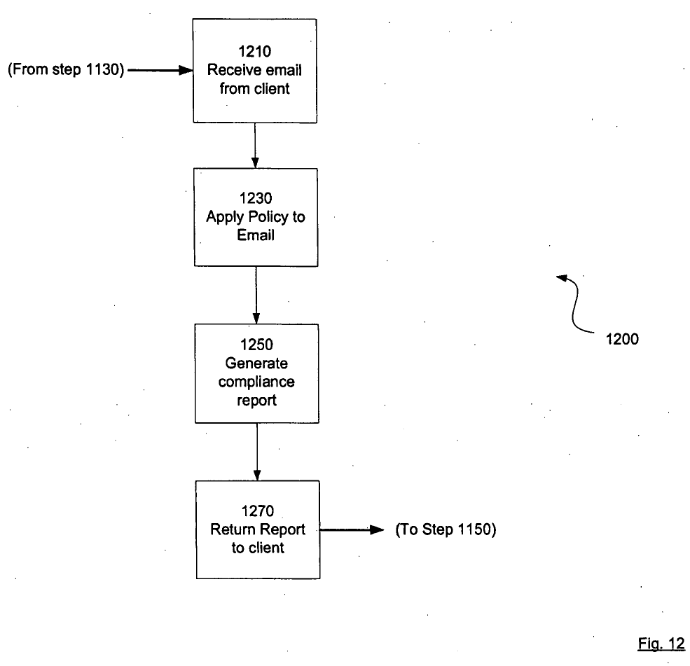

Referring now to FIGS. 11 and 12, additional methods for managing electronic communications in accordance with other embodiments of the invention are provided. To assist in the explanation of these methods, it will be assumed that they are performed using system 50. Furthermore, the following discussion of these methods will lead to further understanding of system 50 and its components. However, it is to be understood that system 50 and/or the methods can be varied, and need not work exactly as discussed herein in conjunction with each other, and that such variations are within the scope of the present invention. For example, the order of performance of various steps can be varied, and certain steps can be omitted and/or additional steps added as desired.

With this in mind, methods 1100 and 1200 are generally directed to management of an email that is inbound from network 74 and destined to client 54. Method 1100 in FIG. 11 is a method for managing inbound emails at a client such as client 54. Method 1200 in FIG. 12 is a method for managing inbound emails at a policy server such a policy server 58. For convenience, these methods will be explained in conjunction with each other.

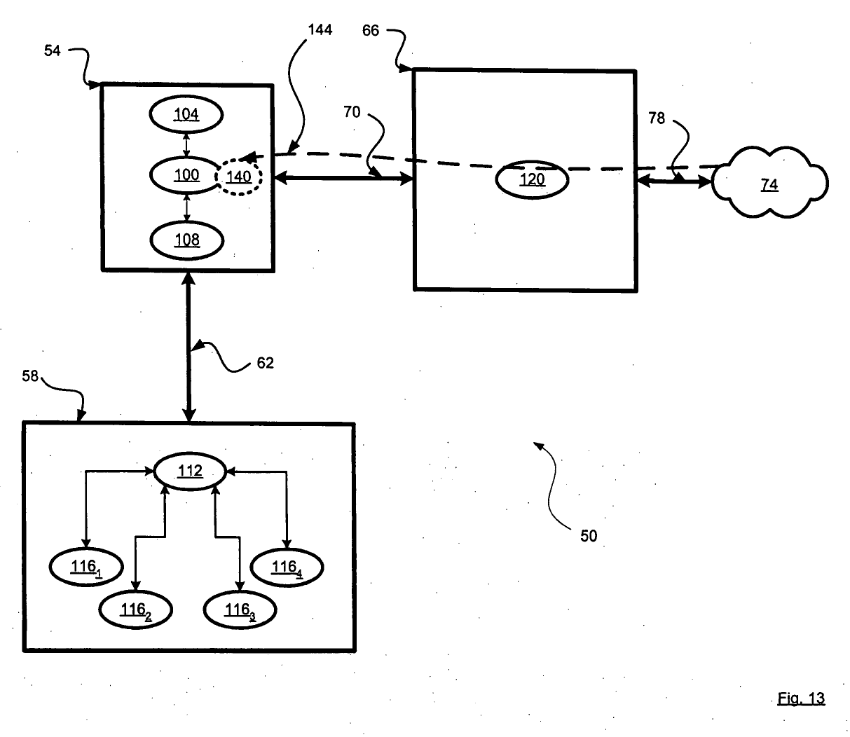

Referring now to FIG. 11, beginning first at step 1100, an email is received at the client. This step is represented in FIG. 13, as an incoming email 140 being delivered from network 74 to client 54 via mail server 66 along a pathway indicated as 144. In the present example, it is assumed that email 140 is encrypted, and in order to represent this encryption, email 140 is shown as an oval with dashed lines. Email 140 is delivered to client 54 by mail server 66 and mail transport agent 120 in the usual manner.

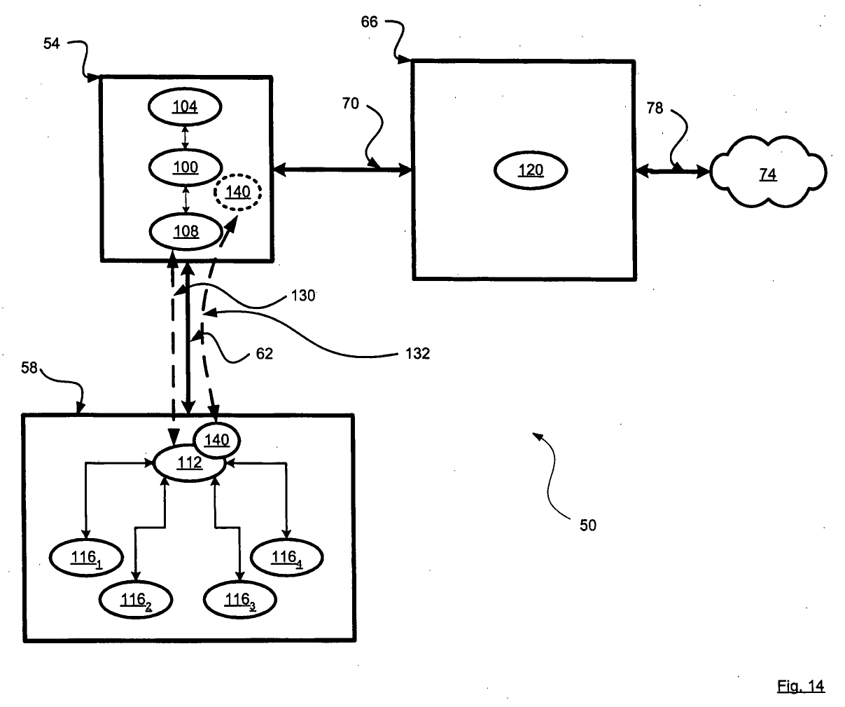

Next, at step 1130, the incoming email is forwarded to the policy server. Continuing with the foregoing example, the performance of this step is represented in FIG. 14. Since email 140 is encrypted, then as part of performing step 1130, security module 108 will access key store 104 and decrypt email 140 in the usual manner. The remainder of step 1130 is performed in substantially the same manner as step 310 in method 300, as security module 108 sends decrypted email 140 over layer 130 to policy manager 112 along the path indicated at 132 so that a decrypted copy of email 140 is locally resident on policy server 58. (The decrypted copy of email 140 is shown as an oval with a solid line.)

At this point, method 1100 pauses for the performance of method 1200. Before completing the description of method 1100, reference will turn to method 1200 on FIG. 12. Beginning first at step 1210, the email 140 is received from client 54, as forwarded at step 1130, and a copy of which is now locally resident on policy server 58 as shown in FIG. 14.

Next, at step 1230, the policy is applied to the email. As previously discussed, any one or more of policy components 116 can now be applied against email 140 to verify whether it is in compliance with a pre-defined policy (or more than one policy) associated with inbound emails for client 54. In the case of inbound email 140, virus scanner policy component 116₂ and spam scanner policy component 116₃ can be used to verify that no viruses or spam were associated with that inbound email 140. Again, however, the types of policies are not particularly limited, and recipient rule engine policy component 116₄ could be modified to be a sender rule engine policy component, so that email 140 could be subject to restrictions according to the sender of that email 140. Likewise, sensitivity policy component 116₁ could be invoked as desired or appropriate. Those of skill in the art will now recognize that step 1230 can be performed in substantially the same manner as step 430, but with appropriate modifications to consider the policy management issues associated with inbound emails instead of outbound emails.

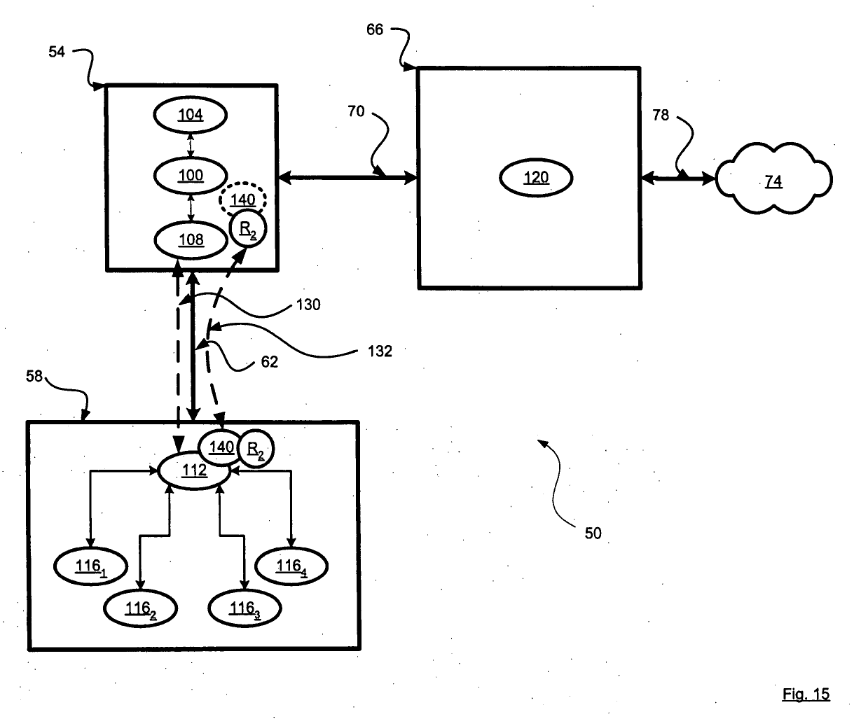

Next, at step 1250, a compliance report is generated. Again, step 1250 can be performed in much the same manner as step 450 of FIG. 4. In its simplest format, step 1250 will result in the generation of a report that is substantially the same format as Report R described above. At step 1270, the report is delivered to the client. Steps 1250 and 1270 are represented in FIG. 15, as Report R₂ is sent back to client 54. At this point, method 1200 ends and method 1100 resumes at step 1150.

Referring again to FIG. 11, at step 1150, the client receives the policy compliance report generated by the policy server. In the present example, security module 108 will receive Report R₂ and a determination is made as to whether the email complied with the policy applied by the policy server. In order to perform this step, security module 108 can examine the contents of Report R₂. Assuming that Report R₂ indicates “Yes”, (i.e. policy server 58 determined that email 140 was in compliance with the prescribed policy), then method 1100 advances from step 1150 to step 1170 at which point email 140 is delivered to the “inbox” of user application 100. Put in other words, where user application 100 is Microsoft Outlook, then at step 1170 email 140 will be presented on the display of client 54 in the “inbox” of Microsoft Outlook in the usual manner, so that the user at client 54 can then open, read, store, reply or perform any other desired usual function on that email 140.

Assuming, however that at step 1150 Report R₂ indicates “No”, (i.e. policy server 58 determined that email 140 was not in compliance with the prescribed policy), then method 1100 advances from step 1150 to step 1190 at which point an exception handling operation occurs. For example, where email 140 was determined to be spam, then email 140 could be quarantined in a separate folder in user application 100 for later review by the user at client 54. In any event, at step 1190 there would typically (though not necessarily) be a message presented to the user at client 54 indicating that policy compliance did not occur, the reasons for such non-compliance and/or what steps can be taken, if any. It should now also be apparent that the types of exception handling at step 1190 are not particularly limited, and can be varied according to the context of the reasons for non-compliance. Likewise, it should now also be understood that step 1230 of method 1200 can be modified to take certain steps to potentially bring email 140 into compliance. For example, if email 140 contained a virus, then such a virus could be automatically quarantined or deleted by virus scanning module 1162. Various other modifications to methods 1100 and 1200 will now occur to those skilled in the art.

While specific combinations of the various features and components of the present invention have been discussed herein, it will be apparent to those of skill in the art that desired subsets of the disclosed features and components and/or alternative combinations of these features and components can be utilized, as desired. For example, where a user at client 54 seeks to encrypt an email prior to the performance of step 310, then security module 108 can perform the additional step of constructing a hash of the email to be encrypted, but still passing the email to policy server 58 in an unencrypted format in substantially the same manner as earlier described, except also including a copy of the hash. When method 400 is performed, policy engine 58 would apply the policy at step 430 to both the email and the hash of the email. The compliance report generated at step 450 would then include the signed policy clearance containing a copy of the one-way (i.e., SHA-1) hash of the email. Once the policy and email 124 are returned to client 54, then security module 108 can encrypt the email and send the report that includes the signed policy clearance and the copy of the hash of the email to mail server 66. The hash can be used for a variety of purposes, such as for verifying compliance via audit—namely, that the purported content scanned matched the content sent.

As another example, and returning now to FIG. 1, in system 50 policy server 58 and mail server 66 are implemented on two separate physical computing environments, each serving a single client 54. However, in a more typical configuration, a plurality of clients 54 and a plurality of policy servers 58 would be present. In this manner, one policy server 58 can serve a plurality of clients 54; and, in turn one mail server 66 can serve a plurality of policy servers 58 and all of the clients 54 respective thereto. All of the entities in system 50 can be owned by a single entity or enterprise, or, across several different enterprises, as desired. In this manner, different policies can be applied to different groups of clients 54, and all of those clients can be served by one mail server 66.

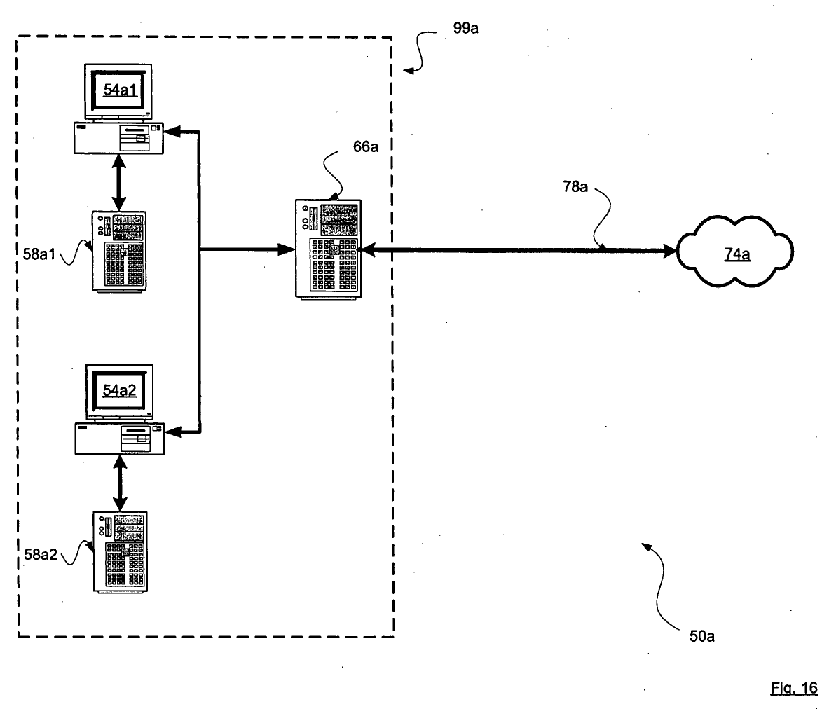

As another example, additional policy servers 58 and/or additional mail servers 66 can be added to system 50. For example, system 50 may include a plurality of clients 54 within a plurality of groups. This can be advantageous in an enterprise environment that has different departments. An example is shown in FIG. 16, showing a system 50a in another embodiment of the invention. System 50a includes many elements that are substantially the same as elements in system 50, and so like elements in system 50a bear the same reference character as their counterparts in system 50, except followed by the suffix “a”. System 50a includes an enterprise 99a that has two groups subject to different policies. The first group includes client 54a1 (but can include a number of additional clients). The second group includes client 54a2 (but can include a number of additional clients). The first group of clients 54a1 is associated with a first policy server 58a1 that administers policies specific to that first group. Likewise, the second group of clients 54a2 can be associated with a second policy server 58a2. Each policy server 58a can enforce individual policies that are appropriate to the clients 54a that are connected thereto. Finally, both groups can be collectively associated with a single mail server 66a as shown in FIG. 16.

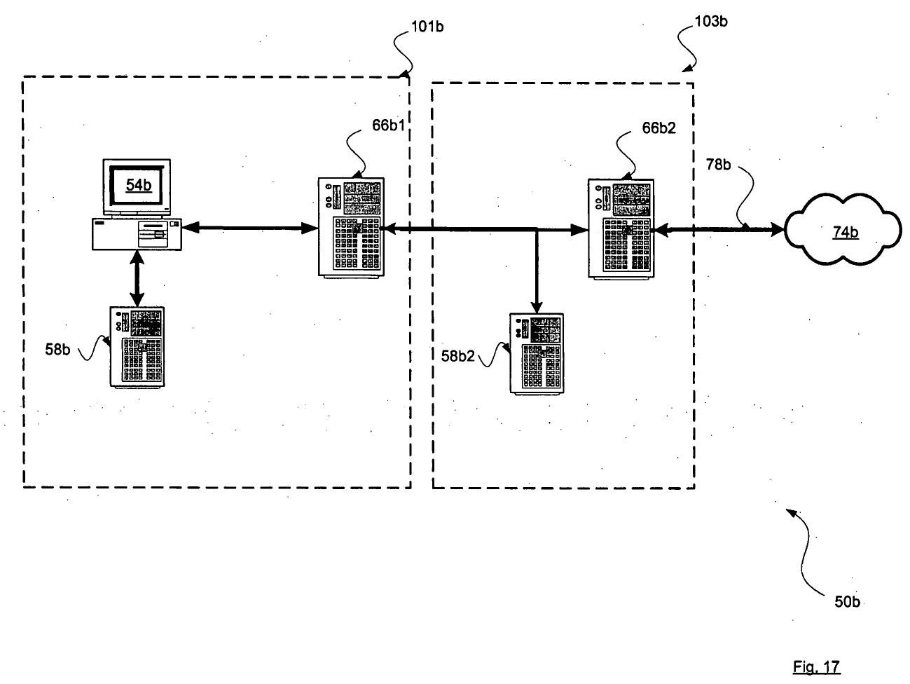

Another example in FIG. 17, shows a system 50b in another embodiment of the invention. System 50b includes many elements that are substantially the same as elements in system 50 and system 50a, and so like elements in system 50b bear the same reference character as their counterparts in system 50, except followed by the suffix “b”. System 50b includes an enterprise 101b. System 50b also includes an Internet Service Provider (“ISP”) 103b that acts on behalf of enterprise 101b. Enterprise 101b has substantially an identical configuration to system 50. ISP 103b itself has a policy server 58b2 that is functionally the same as policy server 58b1, except that policy server 58b2 enforces policies that are global to all of the clients of ISP 103b. Likewise, mail server 66b2 is functionally the same as mail server 66b1, except that mail server 66b2 is configured to cooperate with policy server 58b2. It should now be apparent that system 50b can be combined with system 50a. By the same token, an ISP can implement a policy server and mail server on behalf of a number of individual clients. It should now be apparent that a variety of configurations and combinations of clients, mail servers and policy servers can be effected, and that different entities can operate or control such clients, mail servers and policy servers.

The contents of all third-party documents referenced herein are incorporated herein by reference.

The above-described embodiments of the invention are intended to be examples of the present invention and alterations and modifications may be effected thereto, by those of skill in the art, without departing from the scope of the invention which is defined solely by the claims appended hereto.

1. A system for managing electronic communication comprising:
at least one client connected to a network; each said client operable to execute a user application for managing electronic communications carried over said network; said client further operable to execute a security module for intercepting said communications;
a policy server connected via a link to each said client; said policy server operable to receive said electronic communications from said security module via said link; said policy server operable to execute a policy manager configured for verifying that each of said communications comply with at least one policy and to generate an indicator representing whether each said communication complies with said at least one policy; said policy manager configured to return said indicator to said security module; and,
said security module configured to permit management of said communications at said client based on said indicator.

2. The system of claim 1 wherein said link is a secure communication link.

3. The system of claim 1 wherein said electronic communications are text messages.

4. The system of claim 1 wherein said electronic communications are emails.

5. The system of claim 4 further comprising a mail server between said network and said client; said mail server operable to execute a mail transport agent; said mail transport agent configured to refuse delivery of outbound emails that are generated by said user application over said network if said indicator respective to each of said outbound emails does not indicate compliance with said at least one policy.

6. The system of claim 4 further comprising a mail server between said network and said client; said mail server operable to execute a mail transport agent; said mail transport agent configured to permit delivery of outbound emails that are generated by said user application over said network if said indicator respective- to each of said outbound emails indicates compliance with said at least one policy.

7. The system of claim 6 wherein said client further includes a key store associated with said user application; said key store containing encryption keys for encrypting and decrypting said electronic communications.

8. The system of claim 7 wherein said at least one policy is for verifying whether each of said outbound emails are encrypted and said indicator represents whether each said outbound email is encrypted.

9. The system of claim 8 wherein management of said electronic communication includes automatically encrypting each said outbound email if said indicator reflects that said outbound email is not encrypted.

10. The system of claim 8 wherein said automatic encryption is performed at said client.

11. The system of claim 8 wherein said automatic encryption is performed at said mail server.

12. The system of claim 5 wherein said policy server and said mail server are operated by the same organization.

13. The system of claim 5 wherein said at least one client and said policy server are operated by an enterprise; and said mail server is operated by an Internet Service Provider.

14. The system of claim 5 comprising a plurality of clients and at least one additional policy server connected to said mail server; each of said policy servers connected to respective portions of said plurality of clients; each of said policy servers configured for verifying that each of said communications comply with at least one additional policy that is different from said at least one policy.

15. The system of claim 14 wherein each of said policy servers are operated by different organizations.

16. The system of claim 1 wherein said security module is configured to:
refuse to permit said user application to present an inbound electronic communication to a user at said client that is received at said client over said network if said indicator respective to said inbound electronic communication does not indicate compliance with said at least one policy; and
permit said user application to present an inbound electronic communication to a user at said client that is received at said client over said network if said indicator respective to said inbound electronic communication indicates compliance with said at least one policy.

17. The system of claim 1 wherein said at least one policy server includes one or more of a virus scanner, a spam scanner and a recipient rule engine.

18. The system of claim 1 wherein said at least one policy scanner includes a sensitivity scanner that scans for at least one of pre-defined character strings specified as regular expressions and heuristic or statistical methods to identify potentially sensitive material.

19. The system of claim 1 wherein said policy server further generates a hash of said electronic communication in addition to said indicator; said hash being associated with said indicator and for verifying that said electronic communication is correctly associated with said indicator.

20. A system for managing electronic communication over a network comprising:
at least one client, each said client operable to execute a user application for creating and presenting electronic communications and a security module for intercepting said electronic communications as said communications are sent from said user application or prior to reception by said user application;
a policy server connected via a link to each said client and operable to receive said electronic communications from said security module; said policy server operable to execute a policy manager for verifying that said communications comply with at least one policy and to generate an indicator representing whether said communications comply with said at least one policy; said policy manager further operable to return said indicator to said security module;
said security module further operable to permit further handling of said communications if said indicator represents that said communications comply with said policy.

21. A system for managing electronic communication over a network comprising:
at least one client; each said client operable to execute a user application for creating outbound electronic communications for delivery over said network and for presenting inbound electronic communications received over said network; said client further operable to execute a security module for intercepting said outbound electronic communications as said communications are sent from said user application and for intercepting said inbound electronic communications prior to reception by said user application;
a policy server connected via a link to each said client; said policy server operable to receive said electronic communications from said security module; said policy server operable to execute a policy manager for verifying that said communications comply with at least one policy and to generate an indicator representing whether said communications comply with said at least one policy; said policy manager further operable to return said indicator to said security module; and,
said security module further operable to permit further handling of said communications based on said indicator.

22. A system for managing electronic communication over a network comprising:
at least one client; each said client operable to execute a user application for creating outbound electronic communications for delivery over said network; said client further operable to execute a security module for intercepting said outbound electronic communications as said communications are sent from said user application;
a policy server connected via a link to each said client; said policy server operable to receive said electronic communications from said security module; said policy server operable to execute a policy manager for verifying that said communications comply with at least one policy and to generate an indicator representing whether said communications comply with said at least one policy; said policy manager further operable to return said indicator to said security module; and,
said security module further operable to permit further handling of said communications based on said indicator.

23. A system for managing electronic communication comprising:
at least one client connected to a network; each said client operable to execute a user application for managing electronic communications carried over said network; said client further operable to execute a security module for intercepting said communications;
a policy server connected via a link to each said client; said policy server operable to receive said electronic communications from said security module; said policy server operable to execute a policy manager configured for verifying that each of said communications comply with at least one policy and to generate an indicator representing whether each said communication complies with said at least one policy; said policy manager configured to return said indicator to said security module; and,
said security module configured to permit further handling of said communications by said user application based on said indicator.

24. A method for managing an outbound electronic communication from a client comprising the steps of:
generating an outbound email;
forwarding said email to a policy server for determining whether said email complies with at least one policy;
receiving a policy compliance report from said policy server; and,
forwarding said email and said policy compliance report to a mail server if said policy compliance report indicates said email complies with said at least one policy.

25. The method of claim 24 wherein if said policy compliance report indicates said email conditionally complies with said at least one policy then further comprising the step of, after said receiving step, automatically performing an operation that brings said outbound email into compliance with said at least one policy.

26. The method of claim 24 wherein said operation comprises encrypting said email.

27. The method of claim 24 wherein said operation comprises digitally signing said email.

28. A method for managing an electronic communication at a client comprising the steps of:
intercepting an email at said client;
forwarding said email to a policy server for determining whether said email complies with at least one policy;
receiving a policy compliance report from said policy server; and,
managing said email in accordance with said policy compliance report.

29. A method of managing an electronic communication at a policy server comprising the steps of:
receiving an email from a client;
applying at least one policy to said email;
generating a policy compliance report based on results of said applying step; said report including an indicator whether said email is in compliance with said policy, and,
returning said compliance report to said client.

30. The method of claim 29 wherein said at least one policy server includes one or more of a virus scanner, a spam scanner and a recipient rule engine.

31. The method of claim 29 wherein said at least one policy scanner includes a sensitivity scanner that scans for at least one of pre-defined character strings, social security numbers, account numbers, customer names, and dates of birth.

32. The method of claim 29 wherein said policy server further generates a hash of said electronic communication; said hash incorporated into said policy compliance report and for verifying that said electronic communication is correctly associated with said indicator.

33. A method of managing an electronic communication at a mail server comprising:
receiving an email generated by a client for delivery over a network;
receiving a policy compliance report associated with said email;
forwarding said email for delivery over said network if said policy compliance report indicates said email complies with at least one policy.

34. The method of claim 33 wherein if said policy compliance report indicates said email conditionally complies with said at least one policy then further comprising the step of, after said receiving step, automatically performing an operation that brings said outbound email into compliance with said at least one policy.

35. The method of claim 34 wherein said operation comprises at least one of digitally signing and encrypting said email.
